(19) United States
(12) Patent Application Publication
(10) Pub. No.: US 2014/0050650 A1
(43) Pub. Date: Feb. 20, 2014

(54) SUPERHARD CARBON NITRIDE AND METHOD FOR PRODUCING THE SAME

(71) Applicant: Akitaka SAWAMURA, Osaka-shi (JP)

(72) Inventor: Akitaka SAWAMURA, Osaka-shi (JP)

(73) Assignee: Sumitomo Electric Industries, Ltd., Osaka-shi (JP)

(21) Appl. No.: 13/586,506

(22) Filed: Aug. 15, 2012

(51) Int. Cl. C01B 21/082

(52) U.S. Cl. 423/384

(57) ABSTRACT

C₃N₄ of the present invention has a Mn₃O₄ type crystal structure to thereby have a bulk modulus higher than that of diamond.

### BACKGROUND OF THE INVENTION

1. Field of the Invention

The present invention relates to superhard carbon nitride and a method for producing the same.

2. Description of the Background Art

Hard materials such as diamond and ceramics have been industrially widely used in a broad range of areas such as wear-resistant components and cutting tools. However, due to recent advancement of technology, a material having a higher hardness is demanded.

In such a situation, in recent years, hard materials having a higher hardness have been frequently examined by predictively evaluating the hardness of or the possibility of synthesis of the hard materials by means of first-principles calculations.

For example, an article has been published in which β type C₃N₄ modeled from β type Si₃N₄, which is used as a principal component of practical ceramics, is predicted to have a hardness comparable to that of diamond (A. Y Liu and M. L. Cohen, Phys. Rev. B41 (1990), 10727: Document 1).

Then, zinc blende type having vacancy (A. Y Liu and R. M. Wentzcovitch, Phys. Rev. B50 (1994), 10362: Document 2), α type (D. M. Teter and R. J. Hemley, U.S. Pat. No. 5,981,094, 1999: Document 3 and D. M. Teter and R. J. Hemley, Science 271 (1996), 53: Document 4), willemite II type (Document 3), and spinel type (S. D. Mo, L. Ouyang, W. Y. Ching, I. Tanaka, Y. Koyama, and R. Riedel, Phys. Rev. Left. 83 (1999), 5046: Document 5) have been proposed. Among them, willemite II type C₃N₄ has been predicted to exceed diamond in hardness.

### SUMMARY OF THE INVENTION

As described above, among the currently-known materials, diamond has a very high hardness, and thus materials for which prediction is performed by first-principles calculations are frequently evaluated based on the hardness of diamond.

Therefore, an object of the present invention is to provide a novel hard material having a hardness higher than that of diamond and a method for producing the same.

(1) The present invention is a superhard carbon nitride comprising: C₃N₄ having a Mn₃O₄ type crystal structure to thereby have a bulk modulus higher than that of diamond.

(2) The present invention is also a single crystal of C₃N₄ of the above (1).

(3) The present invention is also a polycrystal of C₃N₄ of the above (1).

(4) The present invention is also a sintered body containing C₃N₄ of the above (1).

(5) The present invention is also a wear-resistant material containing C₃N₄ of the above (1).

(6) The present invention is also a cutting tool containing C₃N₄ of the above (1).

(7) The present invention is also a grinding tool containing C₃N₄ of the above (1).

(8) The present invention is also a method for producing C₃N₄ having a Mn₃O₄ type crystal structure to thereby have a bulk modulus higher than that of diamond, the method comprising the step of combining carbon and nitrogen under a pressure of at least 400 GPa.

### BRIEF DESCRIPTION OF THE DRAWINGS

FIG. 1 is a schematic diagram illustrating the crystal structure of C₃N₄ of an embodiment of the present invention;

FIG. 2 is a table showing crystal structure data of α type C₃N₄ and β type C₃N₄ after optimization;

FIG. 3 is a table showing crystal structure data of willemite II type C₃N₄ and zinc blende type C₃N₄ after optimization;

FIG. 4 is a table showing crystal structure data of Mn₃O₄ type C₃N₄ and spinel type C₃N₄ after optimization;

FIG. 5 is a table showing the value of each parameter of each material which is obtained by fitting a Murnaghan equation of state;

FIG. 6 is a graph showing a result obtained by recalculating a relationship between volume and energy from each parameter obtained by fitting the Murnaghan equation of state;

FIG. 7 is a graph showing a result obtained by converting the relationship between volume and energy in each material shown in FIG. 6 into a relationship between pressure and enthalpy; and

FIG. 8 is a table showing bulk moduli of the six materials, including the Mn₃O₄ type C₃N₄ of the present embodiment, as well as diamond and rock salt type C₃N₄.

### DESCRIPTION OF THE PREFERRED EMBODIMENTS

Hereinafter, a preferred embodiment of the present invention will be described with reference to the drawings.

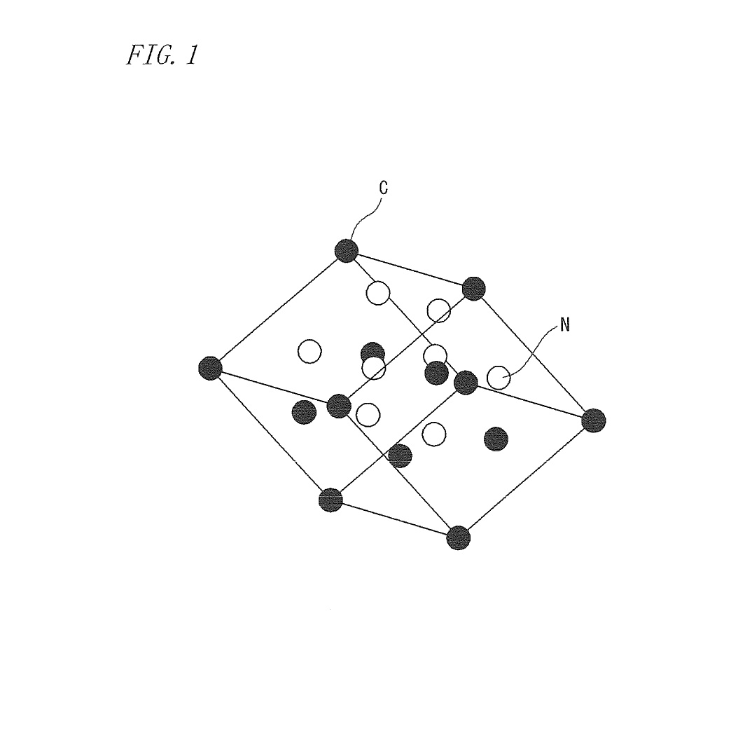

FIG. 1 is a schematic diagram illustrating the crystal structure of C₃N₄ of the present embodiment. In FIG. 1, the crystal structure of the C₃N₄ of the present embodiment is a Mn₃O₄ type. The Mn₃O₄ type crystal structure is a structure in which a spinel type is expanded or contracted in one direction, and is known to easily cause a spontaneous distortion. If the volume contracts due to the spontaneous distortion, increase of the hardness (bulk modulus) can be expected.

The inventor of the present invention has focused on the contraction of the volume caused by the spontaneous distortion in order to obtain a high-hardness material, has conceived an idea of applying the Mn₃O₄ type crystal structure to the crystal structure of C₃N₄, and has completed the present invention.

The Mn₃O₄ type C₃N₄ of the present embodiment has a bulk modulus higher than that of diamond, since its crystal structure is a Mn₃O₄ type. When a Mn₃O₄ type crystal structure is applied to C₃N₄, C is located at the position of Mn, and N is located at the position of O.

The Mn₃O₄ type C₃N₄ of the present embodiment has a higher value of bulk modulus, which is an index of hardness, than that of diamond, and thus is a very hard material.

Therefore, it is possible to industrially widely use the Mn₃O₄ type C₃N₄ of the present embodiment. For example, a single crystal or polycrystal of the Mn₃O₄ type C₃N₄ of the present embodiment is synthesized, and sintered bodies are formed by using these materials and can be used for machining tools for processing metal, ceramics, and the like, such as cutting tools and grinding tools. A machining tool that employs the Mn₃O₄ type C₃N₄ of the present embodiment can have enhanced cutting performance or grinding ability, since the Mn₃O₄ type C₃N₄ is very hard.

In addition, the Mn₃O₄ type C₃N₄ of the present embodiment is very hard and hence has excellent wear resistance. Thus, when the Mn₃O₄ type C₃N₄ of the present embodiment is applied to a portion requiring wear resistance such as a sliding portion of a machine component, the hardness of the Mn₃O₄ type C₃N₄ allows for improving wear resistance such as preventing the sliding portion from being worn out.

With regard to the Mn₃O₄ type C₃N₄ of the present embodiment, the inventor of the present invention initially obtained a detailed crystal structure, calculated a relationship between volume and energy from the obtained crystal structure, obtained a bulk modulus on the basis of the relationship, and evaluated the hardness of the material. In addition, the inventor also evaluated the possibility of synthesis on the basis of the relationship between volume and energy. In the present embodiment, the hardness of the material was evaluated based on bulk modulus.

Further, in addition to the crystal structure of the Mn₃O₄ type C₃N₄ of the present embodiment, the inventor also conducted the same evaluation on α type C₃N₄, β type C₃N₄, willemite II type C₃N₄, zinc blende type C₃N₄, and spinel type C₃N₄ as comparative examples.

First, methods for obtaining crystal structure data and a bulk modulus will be described.

A detailed crystal structure of each material was calculated as numerical data on the basis of first-principles calculations.

The crystal structure was calculated based on the density functional theory and by a pseudopotential method which avoids handling core electrons which hardly contribute to properties. As approximation regarding interaction between electrons, local density approximation was used. As the pseudopotential method, a norm-conserving type was used.

In addition, as software for the above calculations, ABINIT (X. Gonze et. Al., Z. Kristallogr. 220 (2005), 558: Document 6 and X. Gonze et. Al., Computer Phys. Comm. 180 (2009), 2582: Document 7) was used.

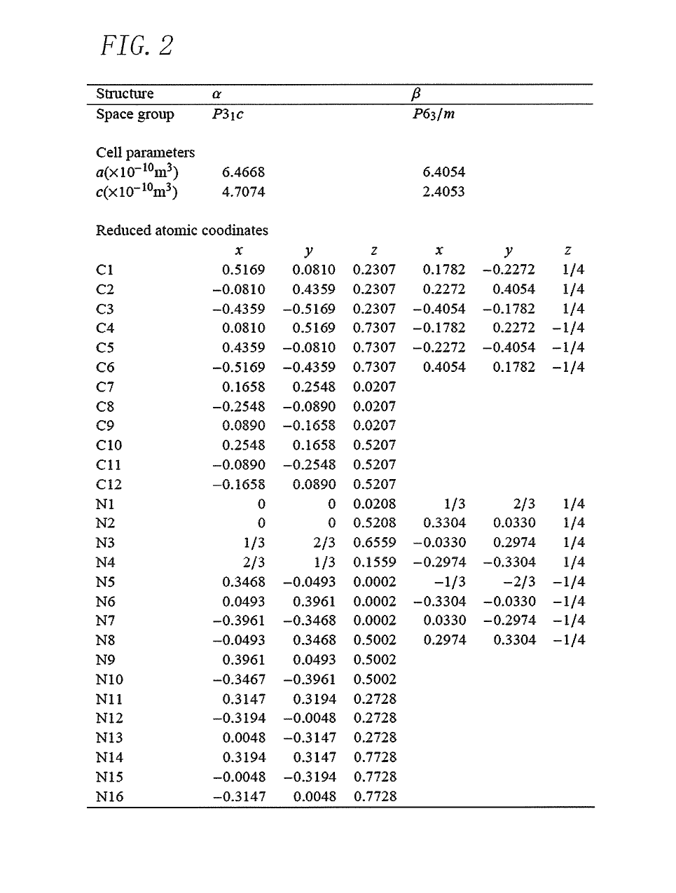

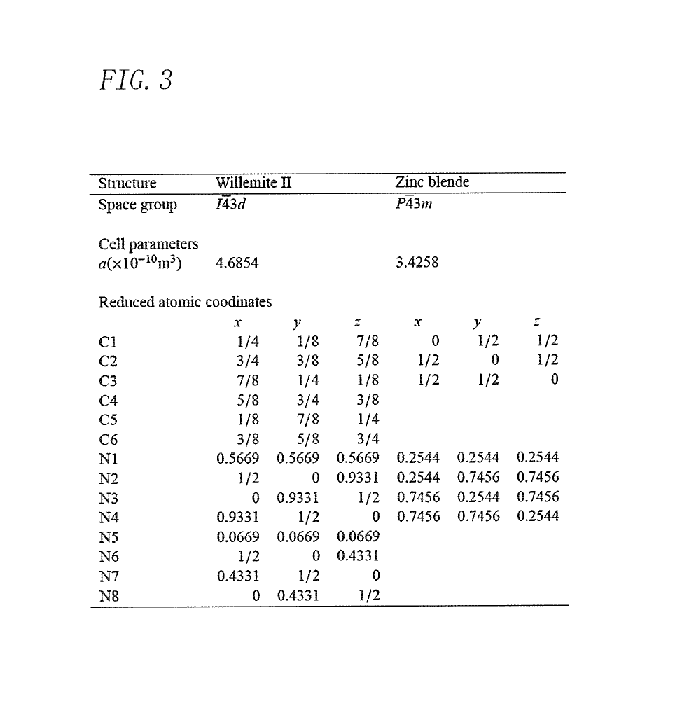

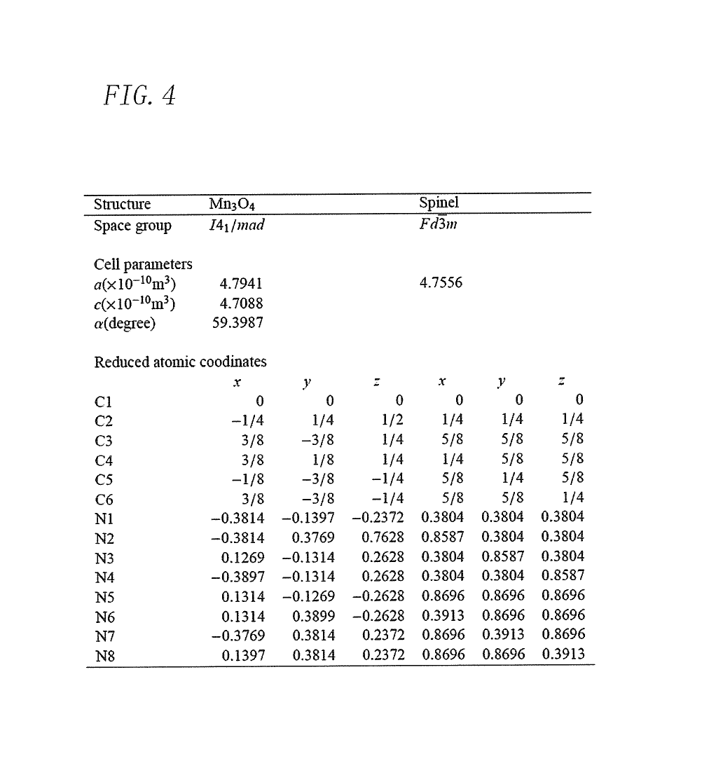

FIG. 2 shows examples of crystal structure data of the α type C₃N₄ and the β type C₃N₄ after optimization, FIG. 3 shows examples of crystal structure data of the willemite II type C₃N₄ and the zinc blende type C₃N₄ after optimization, and FIG. 4 shows examples of crystal structure data of the Mn₃O₄ type C₃N₄ and the spinel type C₃N₄ after optimization.

A bulk modulus is obtained from the crystal structure data. The crystal structure data that were calculated on the basis of the above first-principles calculations and optimized were used for obtaining a relationship between volume and energy in each material.

Specifically, an energy was calculated by designating a volume and optimizing the other degrees of freedom, whereby variation of energy with respect to volume variation in each material was obtained.

Next, a relationship between volume and energy in each material was fitted with a Murnaghan equation of state represented by the following Equation (1).

$$E = \frac{{B}_{0} V}{{B}^{′} ( {B}^{′} - 1 )} [ {B}^{′} ( 1 - \frac{{V}_{0}}{V} ) + {( \frac{{V}_{0}}{V} )}^{{B}^{′}} - 1 ] + {E}_{0} \qquad ( 1 )$$

The Murnaghan equation of state represented by the above Equation (1) is an equation representing the relationship between volume V and energy E and includes, as adjustable parameters, a volume V₀ under zero pressure, an energy E₀ under zero pressure, a bulk modulus B₀ under zero pressure, and pressure dependence B′ of the bulk modulus under zero pressure. The pressure dependence B′ is represented by the following Equation (2).

$${B}^{′} = \frac{\partial {B}_{0}}{\partial P} \qquad ( 2 )$$

Each parameter in the above Equation (1) is adjusted to fit the Equation (1) to the relationship between volume and energy in each material, and the value of each parameter when fitting is obtained.

By so doing, the bulk modulus B₀ under zero pressure, which is a value for evaluating the hardness of the material, can be obtained.

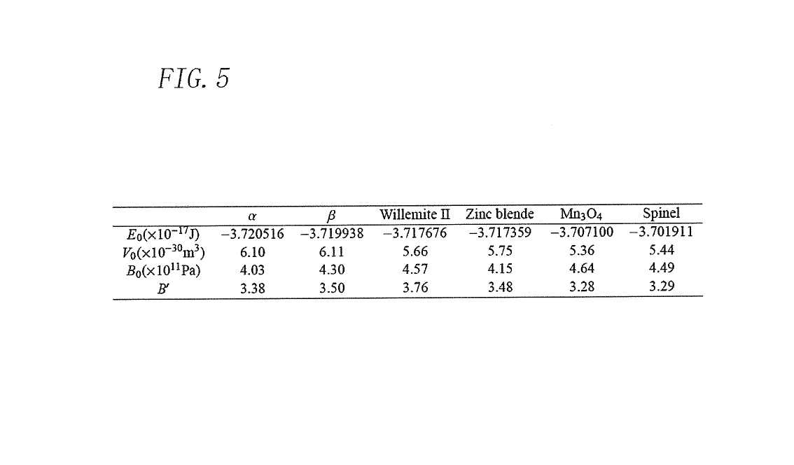

FIG. 5 shows the value of each parameter of each material which is obtained by fitting the Murnaghan equation of state. It is recognized that the bulk modulus B₀ of the Mn₃O₄ type C₃N₄ of the present embodiment is higher than those of the other materials.

Next, the possibility of synthesis of the Mn₃O₄ type C₃N₄ of the present embodiment will be described.

The possibility of synthesis was evaluated by obtaining a relationship between pressure and enthalpy by using each parameter described above.

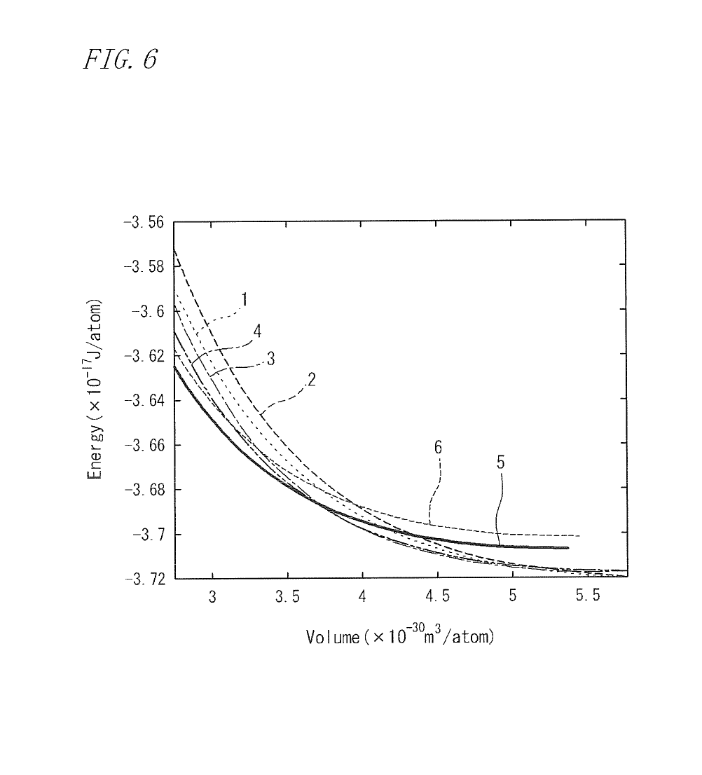

The relationship between volume and energy was recalculated by using each parameter described above. The result is shown in FIG. 6. In FIG. 6, the horizontal axis indicates volume, and the vertical axis indicates energy. A dashed line 1 indicates a relationship between volume and energy in the α type C₃N₄; a dashed line 2 indicates a relationship between volume and energy in the β type C₃N₄; an alternate long and short dash line 3 indicates a relationship between volume and energy in the willemite II type C₃N₄; an alternate long and two short dashes line 4 indicates a relationship between volume and energy in the zinc blende type C₃N₄; a solid line 5 indicates a relationship between volume and energy in the Mn₃O₄ type C₃N₄; and a dashed line 6 indicates a relationship between volume and energy in the spinel type C₃N₄.

Here, a pressure P which is an easily-controllable variable in producing each material is represented by the following Equation (3).

$$P = - \frac{\partial E}{\partial V} \qquad ( 3 )$$

In addition, an enthalpy H which is a relative index of whether it is in a phase that is easily generated under a finite pressure is represented by the following Equation (4).

H=E+PV (4)

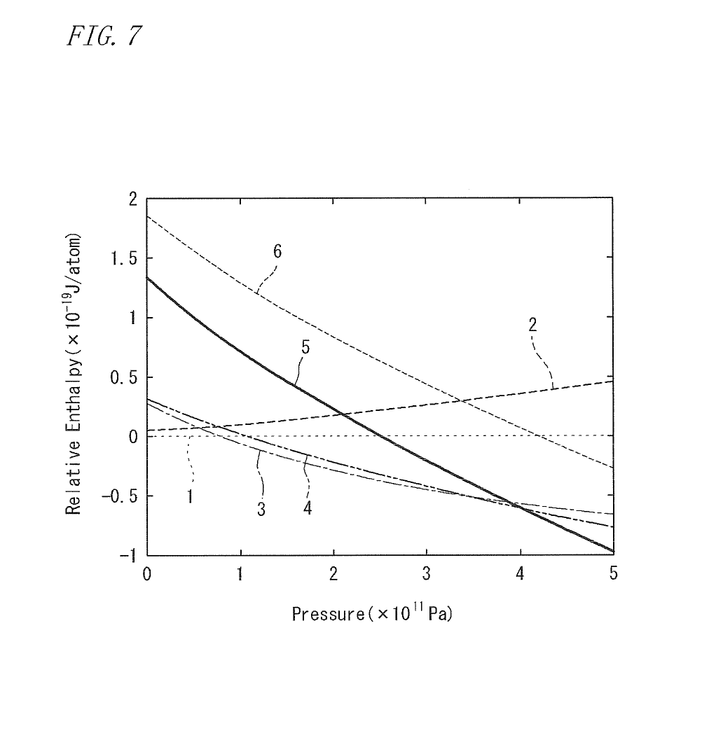

On the basis of the above Equations (3) and (4), the relationship between volume and energy in each material shown in FIG. 6 was converted into a relationship between pressure and enthalpy. The result is shown in FIG. 7. In FIG. 7, the horizontal axis indicates pressure, and the vertical axis indicates enthalpy. A dashed line 1 indicates a relationship between pressure and enthalpy in the α type C₃N₄; a dashed line 2 indicates a relationship between pressure and enthalpy in the β type C₃N₄; an alternate long and short dash line 3 indicates a relationship between pressure and enthalpy in the willemite II type C₃N₄; an alternate long and two short dashes line 4 indicates a relationship between pressure and enthalpy in the zinc blende type C₃N₄; a solid line 5 indicates a relationship between pressure and enthalpy in the Mn₃O₄ type C₃N₄; and a dashed line 6 indicates a relationship between pressure and enthalpy in the spinel type C₃N₄.

The enthalpy of each material in FIG. 7 is represented as a relative value based on the enthalpy of the α type C₃N₄.

The enthalpy H indicates that the material having the smallest value of the enthalpy H is stable under equal pressure. In FIG. 7, the α type C₃N₄ is the most stable under zero pressure, and the willemite II type C₃N₄ becomes stable around 80 GPa with pressurization. With further pressurization, the zinc blende type C₃N₄ becomes stable around 350 GPa, and the Mn₃O₄ type C₃N₄ becomes stable when the pressure reaches around 400 GPa.

In other words, in FIG. 7, the enthalpy H of the Mn₃O₄ type C₃N₄ is the smallest under a pressure equal to or higher than about 400 GPa. Thus, it is recognized that if the α type C₃N₄ can be synthesized as a precursor, it is possible to synthesize the Mn₃O₄ type C₃N₄ by pressurizing the α type C₃N₄ to about 400 GPa or more.

As a specific method for producing the Mn₃O₄ type C₃N₄ of the present embodiment, the following method is considered. Specifically, carbon and nitrogen, which are raw materials, are put into a vessel together, and pressurized to 400 GPa or more while being kept at 1000 to several thousands ° C. By so doing, carbon and nitrogen within the vessel are combined to obtain Mn₃O₄ type C₃N₄. The pressure during the pressurization is based on the above-described evaluation with the enthalpy H.

Next, evaluation of the bulk modulus will be described. In the present embodiment, with regard to diamond and rock salt type C₃N₄ as well, a bulk modulus, which is an index of hardness, was obtained by the same method as that for the six materials described above.

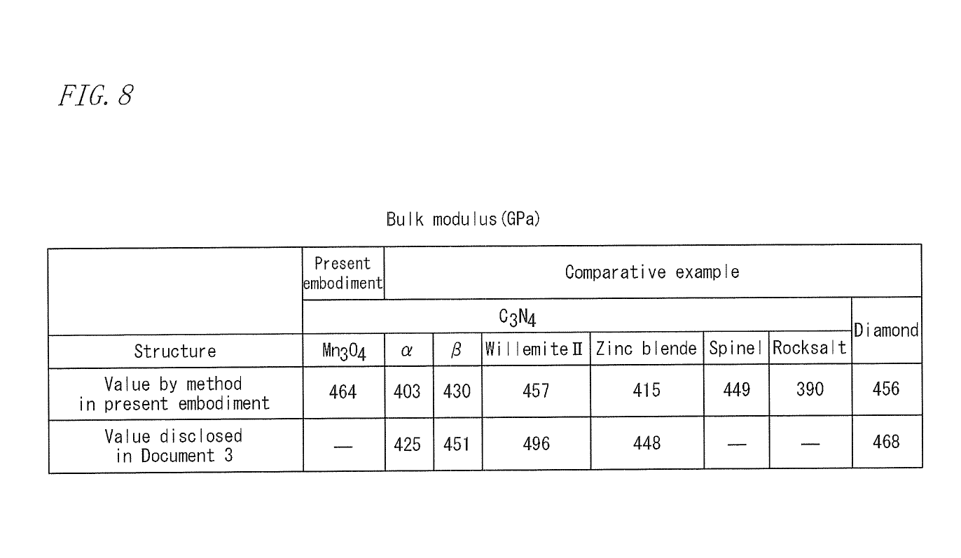

FIG. 8 shows the bulk moduli of the above-described six materials, including the Mn₃O₄ type C₃N₄ of the present embodiment, as well as diamond and the rock salt type C₃N₄.

In FIG. 8, when the bulk moduli obtained by the method in the present embodiment are compared to each other, the bulk modulus of the Mn₃O₄ type C₃N₄ of the present embodiment is 464 GPa which is higher than those of any of the materials including diamond and the willemite II type C₃N₄ proposed in Document 3.

In addition, the bulk modulus (457 GPa) of the willemite II type C₃N₄ is slightly higher than the bulk modulus (456 GPa) of diamond.

It should be noted that when the bulk modulus of the Mn₃O₄ type C₃N₄ of the present embodiment obtained by the method in the present embodiment is compared to the bulk modulus of the willemite II type C3N4 disclosed in Document 3, the latter is higher.

The reason is thought to be that a result of calculation of a bulk modulus by first-principles calculations slightly varies depending on the calculation method and setting of parameters. Thus, it is inappropriate to simply compare values obtained by different methods.

When the bulk modulus of each material disclosed in Document 3 is compared to the bulk modulus of the corresponding material obtained in the present embodiment, it is recognized that the relative magnitude relationship in bulk modulus for each material agrees with those for the other materials. Further, it is also recognized that the bulk moduli obtained by the method in the present embodiment are relatively lower than the bulk moduli disclosed in Document 3.

Thus, it is recognized that the bulk moduli obtained by the method in the present embodiment tend to appear as low values as compared to the bulk moduli obtained by the method in Document 3.

The bulk modulus of each material should be compared by comparison of values obtained by the same method, and it can be determined that the bulk modulus of the Mn₃O₄ type C₃N₄ of the present embodiment obtained by the method in the present embodiment is relatively higher than the bulk modulus of the willemite II type C₃N₄.

From the above, it is clearly understood that the Mn₃O₄ type C₃N₄ of the present embodiment has a bulk modulus higher than those of diamond and the willemite II type C₃N₄.

Note that the embodiment disclosed herein is merely illustrative in all aspects and should not be recognized as being restrictive. The scope of the present invention is defined by the scope of the claims rather than by the meaning described above, and is intended to include meaning equivalent to the scope of the claims and all modifications within the scope.

What is claimed is:

1. A superhard carbon nitride comprising:
C₃N₄ having a Mn₃O₄ type crystal structure to thereby have a bulk modulus higher than that of diamond.

2. A single crystal of C₃N₄ according to claim 1.

3. A polycrystal of C₃N₄ according to claim 1.

4. A sintered body containing C₃N₄ according to claim 1.

5. A wear-resistant material containing C₃N₄ according to claim 1.

6. A cutting tool containing C₃N₄ according to claim 1.

7. A grinding tool containing C₃N₄ according to claim 1.

8. A method for producing C₃N₄ having a Mn₃O₄ type crystal structure to thereby have a bulk modulus higher than that of diamond, the method comprising the step of:
combining carbon and nitrogen under a pressure of at least 400 GPa.
